(19) United States
(12) Patent Application Publication
(10) Pub. No.: US 2019/0003320 A1
(43) Pub. Date: Jan. 3, 2019

(54) TURBOMACHINE ROTOR BLADE

(71) Applicant: General Electric Company, Schenectady, NY (US)

(72) Inventors: Robert Alan Brittingham, Greer, SC (US); James Tyson Balkcum, III, Taylors, SC (US)

(21) Appl. No.: 15/638,530

(22) Filed: Jun. 30, 2017

(51) Int. Cl. F01D 5/20; F01D 5/18; F01D 5/14

(52) U.S. Cl. CPC F01D 5/20; F01D 5/187; F01D 5/225; F01D 5/18; F01D 5/147

(57) ABSTRACT

The present disclosure is directed to a rotor blade for a turbomachine. The rotor blade includes an airfoil defining a cooling passage and a tip shroud coupled to the airfoil. The tip shroud and the airfoil define a cooling core in fluid communication with the cooling passage. The tip shroud including a forward exterior wall, an aft exterior wall spaced apart from the forward exterior wall along an axial direction, a radially inner exterior wall, a radially outer exterior wall spaced apart from the radially inner wall along a radial direction, a pressure side wall, and a suction side wall spaced apart from the pressure side wall along a circumferential direction. The tip shroud further includes first and second interior walls positioned within the cooling core. The first interior wall is non-coplanar with the second interior wall in the axial, radial, and circumferential directions.

### FIELD

The present disclosure generally relates to turbomachines. More particularly, the present disclosure relates to rotor blades for turbomachines.

### BACKGROUND

A gas turbine engine generally includes a compressor section, a combustion section, and a turbine section. The compressor section progressively increases the pressure of air entering the gas turbine engine and supplies this compressed air to the combustion section. The compressed air and a fuel (e.g., natural gas) mix within the combustion section and burn within one or more combustion chambers to generate high pressure and high temperature combustion gases. The combustion gases flow from the combustion section into the turbine section where they expand to produce work. For example, expansion of the combustion gases in the turbine section may rotate a rotor shaft connected to a generator to produce electricity.

The turbine section generally includes a plurality of rotor blades. Each rotor blade includes an airfoil positioned within the flow of the combustion gases. In this respect, the rotor blades extract kinetic energy and/or thermal energy from the combustion gases flowing through the turbine section. Certain rotor blades may include a tip shroud coupled to the radially outer end of the airfoil. The tip shroud reduces the amount of combustion gases leaking past the rotor blade.

The rotor blades generally operate in extremely high temperature environments. As such, the tip shroud of each rotor blade may define a cooling core having various cooling channels through which a coolant may flow. Nevertheless, the conventional cooling core configurations may limit the effectiveness of the coolant. This, in turn, may limit the operating temperature and/or the service life of the rotor blade.

### BRIEF DESCRIPTION

Aspects and advantages of the technology will be set forth in part in the following description, or may be obvious from the description, or may be learned through practice of the technology.

In one aspect, the present disclosure is directed to a rotor blade for a turbomachine. The rotor blade defines an axial direction, a radial direction, and a circumferential direction. The rotor blade includes an airfoil defining a cooling passage and a tip shroud coupled to the airfoil. The tip shroud and the airfoil define a cooling core in fluid communication with the cooling passage. The tip shroud including a forward exterior wall, an aft exterior wall spaced apart from the forward exterior wall along the axial direction, a radially inner exterior wall, a radially outer exterior wall spaced apart from the radially inner wall along the radial direction, a pressure side wall, and a suction side wall spaced apart from the pressure side wall along the circumferential direction. The tip shroud further includes first and second interior walls positioned within the cooling core. The first interior wall is non-coplanar with the second interior wall in the axial, radial, and circumferential directions.

In another aspect, the present disclosure is directed to a turbomachine including a turbine section having one or more rotor blades. Each rotor blade defines an axial direction, a radial direction, and a circumferential direction. Each rotor blade includes an airfoil defining a cooling passage and a tip shroud coupled to the airfoil. The tip shroud and the airfoil define a cooling core in fluid communication with the cooling passage. The tip shroud including a forward exterior wall, an aft exterior wall spaced apart from the forward exterior wall along the axial direction, a radially inner exterior wall, a radially outer exterior wall spaced apart from the radially inner wall along the radial direction, a pressure side wall, and a suction side wall spaced apart from the pressure side wall along the circumferential direction. The tip shroud further includes first and second interior walls positioned within the cooling core. The first interior wall is non-coplanar with the second interior wall in the axial, radial, and circumferential directions.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 is a schematic view of an exemplary gas turbine engine in accordance with embodiments of the present disclosure;

FIG. 2 is a side view of an exemplary rotor blade in accordance with embodiments of the present disclosure;

FIG. 3 is a cross-sectional view of an exemplary airfoil in accordance with embodiments of the present disclosure;

FIG. 4 is a cross-sectional view of one embodiment of a tip shroud, illustrating a cooling core in accordance with embodiments of the present disclosure; and

FIG. 5 is an enlarged, perspective view of a portion of the cooling core identified by circle 5 in FIG. 4, illustrating a plurality of interior walls defining a flow passage within the cooling core in accordance with the embodiments disclosed herein.

Repeat use of reference characters in the present specification and drawings is intended to represent the same or analogous features or elements of the present technology.

### DETAILED DESCRIPTION

Reference will now be made in detail to present embodiments of the technology, one or more examples of which are illustrated in the accompanying drawings. The detailed description uses numerical and letter designations to refer to features in the drawings. Like or similar designations in the drawings and description have been used to refer to like or similar parts of the technology. As used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

Each example is provided by way of explanation of the technology, not limitation of the technology. In fact, it will be apparent to those skilled in the art that modifications and variations can be made in the present technology without departing from the scope or spirit thereof. For instance, features illustrated or described as part of one embodiment may be used on another embodiment to yield a still further embodiment. Thus, it is intended that the present technology covers such modifications and variations as come within the scope of the appended claims and their equivalents.

Although an industrial or land-based gas turbine is shown and described herein, the present technology as shown and described herein is not limited to a land-based and/or industrial gas turbine unless otherwise specified in the claims. For example, the technology as described herein may be used in any type of turbomachine including, but not limited to, aviation gas turbines (e.g., turbofans, etc.), steam turbines, and marine gas turbines.

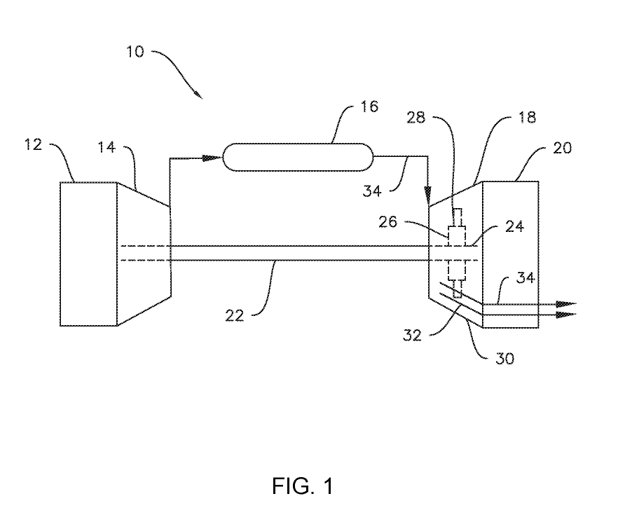

Referring now to the drawings, wherein identical numerals indicate the same elements throughout the figures, FIG. 1 schematically illustrates a gas turbine engine 10. As shown, the gas turbine engine 10 may include an inlet section 12, a compressor section 14, a combustion section 16, a turbine section 18, and an exhaust section 20. The compressor section 14 and turbine section 18 may be coupled by a shaft 22. The shaft 22 may be a single shaft or a plurality of shaft segments coupled together to form the shaft 22.

The turbine section 18 may include a rotor shaft 24 having a plurality of rotor disks 26 (one of which is shown) and a plurality of rotor blades 28. Each rotor blade 28 extends radially outward from and interconnects to one of the rotor disks 26. Each rotor disk 26, in turn, may be coupled to a portion of the rotor shaft 24 that extends through the turbine section 18. The turbine section 18 further includes an outer casing 30 that circumferentially surrounds the rotor shaft 24 and the rotor blades 28, thereby at least partially defining a hot gas path 32 through the turbine section 18.

During operation, the gas turbine engine 10 produces mechanical rotational energy, which may, e.g., be used to generate electricity. More specifically, air enters the inlet section 12 of the gas turbine engine 10. From the inlet section 12, the air flows into the compressor 14, where it is progressively compressed to provide compressed air to the combustion section 16. The compressed air in the combustion section 16 mixes with a fuel to form an air-fuel mixture, which combusts to produce high temperature and high pressure combustion gases 34. The combustion gases 34 then flow through the turbine 18, which extracts kinetic and/or thermal energy from the combustion gases 34. This energy extraction rotates the rotor shaft 24, thereby creating mechanical rotational energy for powering the compressor section 14 and/or generating electricity. The combustion gases 34 exit the gas turbine engine 10 through the exhaust section 20.

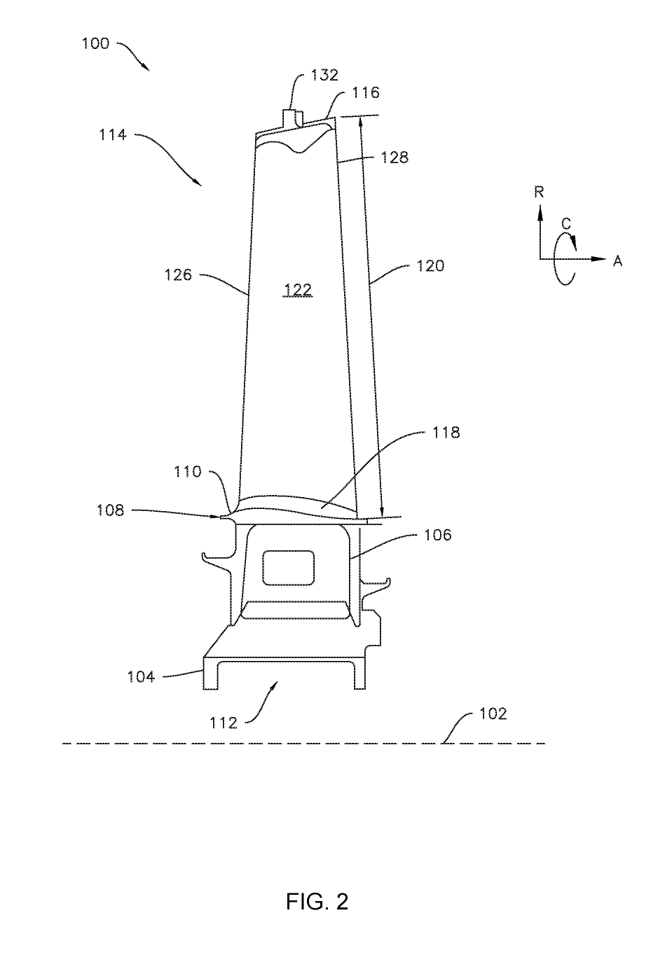

FIG. 2 is a side view of an exemplary rotor blade 100, which may be incorporated into the turbine section 18 of the gas turbine engine 10 in place of the rotor blade 28. As shown, the rotor blade 100 defines an axial direction A, a radial direction R, and a circumferential direction C. In general, the axial direction A extends parallel to an axial centerline 102 of the shaft 24 (FIG. 1), the radial direction R extends generally orthogonal to the axial centerline 102, and the circumferential direction C extends generally concentrically around the axial centerline 102. The rotor blade 100 may also be incorporated into the compressor section 14 of the gas turbine engine 10 (FIG. 1).

As illustrated in FIG. 2, the rotor blade 100 may include a dovetail 104, a shank portion 106, and a platform 108. More specifically, the dovetail 104 secures the rotor blade 100 to the rotor disk 26 (FIG. 1). The shank portion 106 couples to and extends radially outward from the dovetail 104. The platform 108 couples to and extends radially outward from the shank portion 106. The platform 108 includes a radially outer surface 110, which generally serves as a radially inward flow boundary for the combustion gases 34 flowing through the hot gas path 32 of the turbine section 18 (FIG. 1). The dovetail 104, the shank portion 106, and the platform 108 may define an intake port 112, which permits a coolant (e.g., bleed air from the compressor section 14) to enter the rotor blade 100. In the embodiment shown in FIG. 2, the dovetail 104 is an axial entry fir tree-type dovetail. Alternately, the dovetail 104 may be any suitable type of dovetail. In fact, the dovetail 104, shank portion 106, and/or platform 108 may have any suitable configurations.

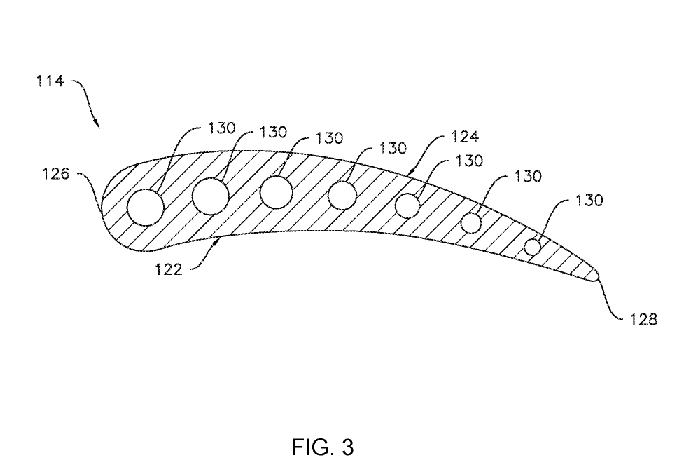

Referring now to FIGS. 2 and 3, the rotor blade 100 further includes an airfoil 114. In particular, the airfoil 114 extends radially outward from the radially outer surface 110 of the platform 108 to a tip shroud 116. The airfoil 114 couples to the platform 108 at a root 118 (i.e., the intersection between the airfoil 114 and the platform 116). In this respect, the airfoil 118 defines an airfoil span 120 extending between the root 118 and the tip shroud 116. The airfoil 114 also includes a pressure side surface 122 and an opposing suction side surface 124 (FIG. 3). The pressure side surface 122 and the suction side surface 124 are joined together or interconnected at a leading edge 126 of the airfoil 114 and a trailing edge 128 of the airfoil 114. As shown, the leading edge 126 is oriented into the flow of combustion gases 34 (FIG. 1), while the trailing edge 128 is spaced apart from and positioned downstream of the leading edge 126. The pressure side surface 122 and the suction side surface 124 are continuous about the leading edge 126 and the trailing edge 128. Furthermore, the pressure side surface 122 is generally concave, and the suction side surface 124 is generally convex.

As shown in FIG. 3, the airfoil 114 may define one or more cooling passages 130 extending therethrough. More specifically, the cooling passages 130 may extend from the tip shroud 116 radially inward to the intake port 112. In this respect, coolant may flow through the cooling passages 130 from the intake port 112 to the tip shroud 116. In the embodiment shown in FIG. 3, for example, the airfoil 114 defines seven cooling passages 130. In alternate embodiments, however, the airfoil 114 may define more or fewer cooling passages 130.

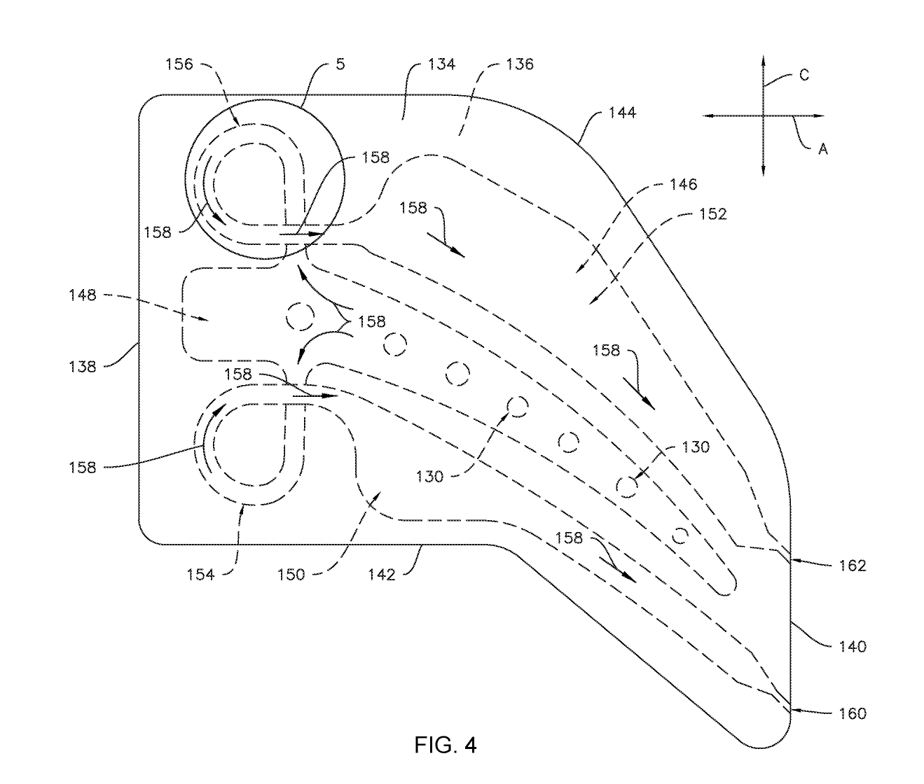

As mentioned above, the rotor blade 100 includes the tip shroud 116. As illustrated in FIGS. 2 and 4, the tip shroud 116 couples to the radially outer end of the airfoil 114 and generally defines the radially outermost portion of the rotor blade 100. In this respect, the tip shroud 116 reduces the amount of the combustion gases 34 (FIG. 1) that escape past the rotor blade 100. As shown in FIG. 2, the tip shroud 116 may include a seal rail 132. Alternate embodiments, however, may include more seal rails 132 (e.g., two seal rails 132, three seal rails 132, etc.) or no seal rails 132.

Referring now to FIG. 4, the tip shroud 116 includes various exterior walls. More specifically, the tip shroud 116 includes a radially outer exterior wall 134. Although omitted from FIG. 4 for clarity, the seal rail(s) 132 may couple to and exterior radially outward from the radially outer exterior wall 134. The tip shroud 116 also includes a radially inner exterior wall 136, which couples to a radially outer end of the airfoil 114. As such, the radially inner exterior wall 136 is spaced apart from the radially outer wall 134 along the radial direction R. The tip shroud 116 also includes forward and aft exterior walls 138, 140, which extend between the radially outer and inner walls 134, 136. As shown, the forward and aft walls 138, 140 are spaced apart along the axial direction A. Furthermore, the tip shroud 116 includes a pressure side wall 142 and a suction side wall 144 spaced apart from the pressure side wall 142 along the circumferential direction C. In alternate embodiments, however, the tip shroud 116 may have any suitable configuration of exterior walls.

The exterior walls 134, 136, 138, 140, 142, 144 of the tip shroud 116 and the airfoil 114 define a cooling core 146. As will be described in greater detail below, the coolant flows through the cooling core 146, thereby cooling the tip shroud 116. In this respect, the cooling core 146 may include various chambers and channels therein. For example, in the embodiment shown in FIG. 4, the cooling core 146 includes a central plenum 148 in fluid communication with the cooling passages 130 defined by the airfoil 114. The cooling core 146 may also include a pressure side chamber 150 and a suction side chamber 152. The cooling core 146 may further include a pressure side flow channel 154, which fluidly couples the central plenum 148 and the pressure side chamber 150. Similarly, the cooling core 146 may include a suction side flow channel 156, which fluidly couples the central plenum 148 and the suction side chamber 152. In alternate embodiments, however, the cooling core 146 may have any suitable configuration of chambers and channels.

During operation of the gas turbine engine 10, coolant (e.g., as identified by arrows 158) flows through the cooling core 146 to cool the tip shroud 116. More specifically, the coolant 158 (e.g., bleed air from the compressor section 14) enters the rotor blade 100 through the intake port 112 (FIG. 2). At least a portion of the coolant 158 flows through the cooling passages 130 in the airfoil 114 and into the central plenum 148 in the tip shroud 116. From the central plenum 148, the coolant 158 flows through the pressure side and suction side flow channels 154, 156 and into the pressure side and suction side chambers 150, 152. As such, the coolant 158 flowing through the cooling core 146 convectively cools the various walls of the tip shroud 116. The coolant 158 then respectively exits the pressure side and suction side chambers 150, 152 via the outlets 160, 162 and flows into the hot gas path 32 (FIG. 1).

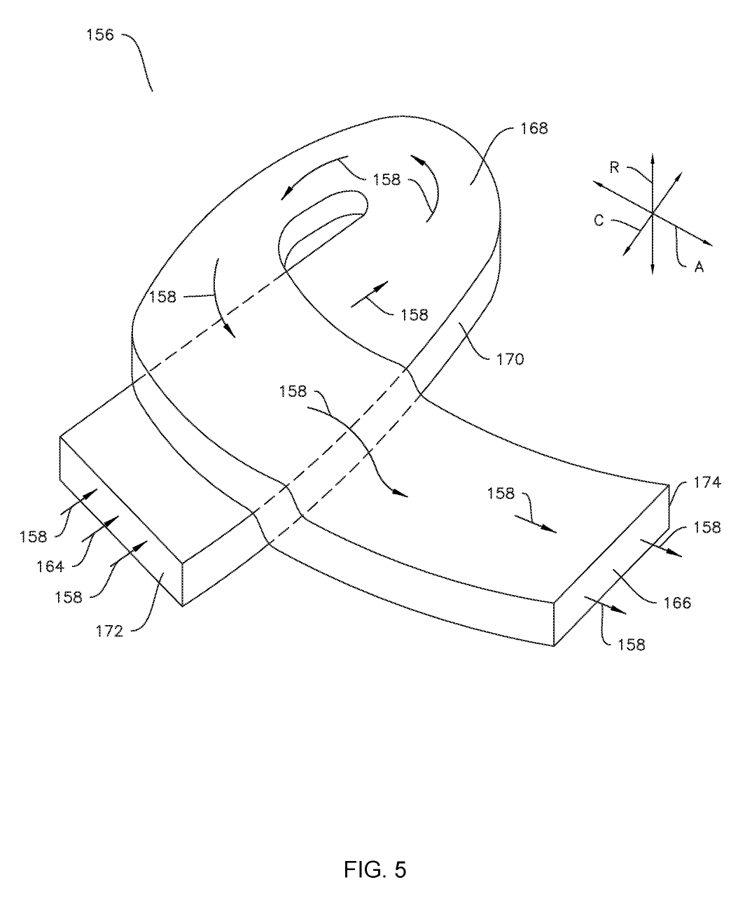

FIG. 5 illustrates the suction side flow passage 156 in greater detail. More specifically, the flow passage 156 may include an inlet 164 in fluid communication with the central plenum 148 and an outlet 166 in fluid communication with the suction side chamber 152. Although, the inlet 164 and the outlet 166 may be in fluid communication with any suitable portion of the cooling core 146. As shown, the flow passage 156 may be curved. For example, the flow passage 156 may be curved in at least two of the axial, radial, or circumferential directions A, R, C in some embodiments. In this respect, the coolant 158 enters the inlet 164 flowing a first direction and exits the outlet 166 flowing in a second direction, which may be different than, such as perpendicular to, the first direction. In particular embodiments, the flow passage 156 may be helical. As such, a first portion of the flow passage 156 may be spaced apart from a second portion of the flow passage 156 along the radial direction R. Furthermore, the first portion of the flow passage 156 may also being aligned with the second portion of the flow passage 156 along the axial or circumferential directions A, C. That is, the helical configuration of the flow passage 156 may permit the flow passage 156 to cross over itself. In alternate embodiments, the flow passage 156 may have any suitable configuration.

The flow passage 156 may be defined by various interior walls positioned within the cooling core 146. In the embodiment shown in FIG. 5, the flow passage 156 is defined by first, second, third, and fourth interior walls 168, 170, 172, 174. As shown, the first interior wall 168 is non-coplanar with the second interior wall 170 in the axial, radial, and circumferential directions A, R, C. That is, the first and second interior walls 168, 170 are not in the same planes defined by the axial, radial, and circumferential directions A, R, C. Similarly, the third interior wall 172 is non-coplanar with the fourth interior wall 174 in the axial, radial, and circumferential directions A, R, C. In alternate embodiments, the flow passage 156 may be defined by any suitable combination and/or configuration of walls so long as at least two of the walls are non-coplanar in the axial, radial, and circumferential directions A, R, C. Furthermore, the at least two interior walls that are non-coplanar in the axial, radial, and circumferential directions A, R, C may not define a flow passage is certain embodiments.

The interior walls 168, 170, 172, 174 may have various configurations to create the requisite non-coplanar relationships. As shown, in certain embodiments, some or all interior walls 168, 170, 172, 174 may be curved. For example, the interior walls 168, 170, 172, 174 may be curved in at least two of the axial, radial, or circumferential directions A, R, C in some embodiments. In further embodiments, some or all interior walls 168, 170, 172, 174 may be helical. For example, a first portion of the first interior wall 168 may be spaced apart from a second portion of the first interior wall 168 along the radial direction R. Furthermore, the first portion of the first interior wall 168 may also being aligned with the second portion of the first interior wall 168 along the axial or circumferential directions A, C. That is, the helical configuration of the first interior wall 168 may permit the first interior wall 168 to cross over itself.

As described in greater detail above, the rotor blade 100 includes the tip shroud 116 having interior walls (e.g., the first and second interior walls 168, 170) that are non-coplanar in the axial, radial, and circumferential directions A, R, C. In this respect, and unlike conventional cooling cores, the cooling core 146 may have cooling channels that are curved the axial, radial, and circumferential directions A, R, C (e.g., helical channels). As such, the cooling core 146 may provide greater cooling to the tip shroud 116 than the cooling cores of conventional tip shroud, thereby permitting higher operating temperatures and/or a longer service life.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A rotor blade for a turbomachine, the rotor blade defining an axial direction, a radial direction, and a circumferential direction, the rotor blade comprising:
an airfoil defining a cooling passage; and
a tip shroud coupled to the airfoil, the tip shroud and the airfoil defining a cooling core in fluid communication with the cooling passage, the tip shroud comprising a forward exterior wall, an aft exterior wall spaced apart from the forward exterior wall along the axial direction, a radially inner exterior wall, a radially outer exterior wall spaced apart from the radially inner wall along the radial direction, a pressure side wall, and a suction side wall spaced apart from the pressure side wall along the circumferential direction, the tip shroud further comprising first and second interior walls positioned within the cooling core, the first interior wall being non-coplanar with the second interior wall in the axial, radial, and circumferential directions.

2. The rotor blade of claim 1, wherein the first or second interior walls are curved.

3. The rotor blade of claim 2, wherein the first or second interior walls are helical.

4. The rotor blade of claim 1, wherein a first portion of the first wall is spaced apart from a second portion of the first wall along the radial direction.

5. The rotor blade of claim 4, wherein the first portion of the first wall is aligned with the second portion of the first wall along the axial or circumferential directions.

6. The rotor blade of claim 1, wherein the first and second interior walls at least partially define a flow passage within the cooling core.

7. The rotor blade of claim 6, wherein the flow passage is curved along at least two of the axial, radial, and circumferential directions.

8. The rotor blade of claim 6, wherein the flow passage is helical.

9. The rotor blade of claim 6, wherein a first portion of the flow passage is spaced apart from a second portion of the flow passage along the radial direction, the first portion of the flow passage being aligned with the second portion of the flow passage along the axial or circumferential directions.

10. The rotor blade of claim 6, wherein coolant enters the flow passage in a first direction and exits the flow passage in a second direction, the first direction being different than the second direction.

11. A turbomachine, comprising:
a turbine section including one or more rotor blades, each rotor blade defining an axial direction, a radial direction, and a circumferential direction, each rotor blade comprising:
an airfoil defining a cooling passage; and
a tip shroud coupled to the airfoil, the tip shroud and the airfoil defining a cooling core in fluid communication with the cooling passage, the tip shroud comprising a forward exterior wall, an aft exterior wall spaced apart from the forward exterior wall along the axial direction, a radially inner exterior wall, a radially outer exterior wall spaced apart from the radially inner wall along the radial direction, a pressure side wall, and a suction side wall spaced apart from the pressure side wall along the circumferential direction, the tip shroud further comprising first and second interior walls positioned within the cooling core, the first interior wall being non-coplanar with the second interior wall in the axial, radial, and circumferential directions.

12. The turbomachine of claim 11, wherein the first or second interior walls are curved.

13. The turbomachine of claim 12, wherein the first or second interior walls are helical.

14. The turbomachine of claim 11, wherein a first portion of the first wall is spaced apart from a second portion of the first wall along the radial direction.

15. The turbomachine of claim 14, wherein the first portion of the first wall is aligned with the second portion of the first wall along the axial or circumferential directions.

16. The turbomachine of claim 11, wherein the first and second interior walls at least partially define a flow passage within the cooling core.

17. The turbomachine of claim 16, wherein the flow passage is curved along at least two of the axial, radial, and circumferential directions.

18. The turbomachine of claim 16, wherein the flow passage is helical.

19. The turbomachine of claim 16, wherein a first portion of the flow passage is spaced apart from a second portion of the flow passage along the radial direction, the first portion of the flow passage being aligned with the second portion of the flow passage along the axial or circumferential directions.

20. The turbomachine of claim 16, wherein coolant enters the flow passage in a first direction and exits the flow passage in a second direction, the first direction being different than the second direction.
